(19) United States
(12) Patent Application Publication
(10) Pub. No.: US 2024/0206502 A1
(43) Pub. Date: Jun. 27, 2024

(54) FOOD MATERIAL RECYCLERS

(71) Applicant: TrendiTech Inc., Burnaby (CA)

(72) Inventors: Craig James MCINTOSH, Burnaby (CA); Carissa Nicole CAMPEOTTO, Burnaby (CA)

(73) Assignee: TrendiTech Inc., Burnaby, BC (CA)

(21) Appl. No.: 18/553,248

(22) PCT Filed: Feb. 15, 2022
(86) PCT No.: PCT/IB2022/051337

§ 371 Date: Sep. 29, 2023

Related U.S. Application Data
(60) Provisional application No. 63/173,197, filed on Apr. 9, 2021.

(51) Int. Cl. A23L 3/00; A23B 7/015; A23B 7/02; A23B 7/024; A23B 7/158; A23L 3/28; A23L 3/3589; A23L 3/44; A23N 12/06

(52) U.S. Cl. CPC A23L 3/001; A23B 7/015; A23B 7/0215; A23B 7/024; A23B 7/158; A23L 3/28; A23L 3/3589; A23L 3/44; A23N 12/06

(57) ABSTRACT

An example of an apparatus to process food material is provided. The apparatus include a transportation platform to be moved from a first location to a second location. The apparatus further includes a sanitization unit mounted at an end of the transportation platform. The sanitization unit is to receive food material, wherein the sanitization unit is to remove contaminants from the food material to provide sanitized food. Furthermore, the apparatus includes a food processor to process the sanitized food. In addition, the apparatus includes a freeze drying system to dehydrate the sanitized food to provide a dry food product.

### BACKGROUND

Food production and consumption is a complicate process from growing the food to consuming the food at home or in a restaurant. As food is processed, waste is generated as portions of the food are removed. The portions that are removed may be done because the portions are deemed to be inedible. In other examples, portions of food may be removed purely for aesthetic purposes. The removed portions of food, which may include skins, stalks, husks, and seeds for plant based foods, are generally discarded due to their low value. In particular, the removed food portions do not generally have the characteristics considered to be appetizing to the general population or otherwise marketable. Other sources of food waste may include food material that has not been processed, such as plants which have not been harvested. It some cases, food waste may include the same nutritional value as other food material which is processed and sold to consumers.

Rising disposable incomes, quality and convenience, increasing levels of fruit and vegetable imports, increasing rates of urbanization, consumer demand for safety, scientific and technological developments, and the growth of fast food chains and supermarkets are driving the growth of the processed plant based food market in developing regions. The convenience of prepared produce and the convenience it provides to consumers is a positive step towards getting people to add much needed fruits and vegetables to their diet. The increase in processing increases the amount of food waste generated that is generally of no commercial value.

### BRIEF DESCRIPTION OF THE DRAWINGS

Reference will now be made, by way of example only, to the accompanying drawings in which:

FIG. 1 is a schematic representation of an example of an apparatus to process food material;

FIG. 2 is a schematic representation of another example of an apparatus to process food material;

FIG. 3 is a schematic representation of an example of a sanitization unit;

FIG. 4 is flowchart of an example of a method of processing food material to produce a dry food product;

FIG. 5 is a schematic representation of another example of an apparatus to process food waste;

FIG. 6 is a schematic representation of another example of an apparatus to process food waste;

FIG. 7A is a schematic representation of an example of a sanitization area in the apparatus show in FIG. 6;

FIG. 7B is a schematic representation of an example of a processing area in the apparatus show in FIG. 6;

FIG. 7C is a schematic representation of an example of a post processing area in the apparatus show in FIG. 6; and

FIG. 7D is a schematic representation of an example of a freeze drying area and a mechanical room in the apparatus show in FIG. 6.

### DETAILED DESCRIPTION

In describing the components of the device and alternative examples of some of these components, the same reference number may be used for elements that are the same as, or similar to, elements described in other examples. As used herein, any usage of terms that suggest an absolute orientation (e.g. “top”, “bottom”, “front”, “back”, etc.) are for illustrative convenience. Such terms are not to be construed in a limiting sense as it is contemplated that various components will, in practice, be utilized in orientations that are the same as, or different than those described or shown.

The use of prepared foods, such as sliced, diced, peeled, cut, and/or ground plant foods have risen dramatically over the past decade and continues to grow, creating large amounts of food waste. This food waste may include items such as peels of produce, outer layers that make a produce less visually desirable, and whole parts or pieces of the produce that may or may not conform to the standards of the food processing facility. In some cases, the food waste may constitute up to about 70% of the ingredients original weight and is generally considered waste that is sent to compost or disposed in a landfill.

In addition to processing plant foods in preparation food for sale to consumers, farms, retailers and consumers also generate food waste at each step. For example, the farm may discard crops of a lower quality visually to increase the price of the remaining crops. The harvesting of crops may also generate food waste from crops falling off the plants or falling out of hoppers during transport The retailers and institutions expect their produce to be near perfect and regulations or store policies may limit the time produce could be stored, used and or sold based on a somewhat arbitrary shelf life. Consumers may purchase excess amounts of food that spoils after a shelf life or prepare too much food for consumption such that a portions is discarded at the end of each meal. Accordingly, there is an ample supply of food waste that is inexpensive access and can be recycled to recover its nutritional value.

An apparatus is provided to recycle food material, such as food waste, from a source to process into a dry food product that is safe for consumption. In the present example, the dried food product is intended for human consumption. However, in other examples, the dried food product may be used for animal consumption. The apparatus may be moved to a location where food waste is generated, such as at a food processing facility. The food waste is then processed by the apparatus and the dry food product is generated at the location. The dry food product may then be provided back to the food processing facility or transported to other locations for use. Although the examples presented below refer to processing food waste, it is to be appreciated by a person of skill with the benefit of this description that any type of food material may be processed. However, due to the relatively lower cost of food waste, the apparatus and methods below are particularly well suited to process food waste.

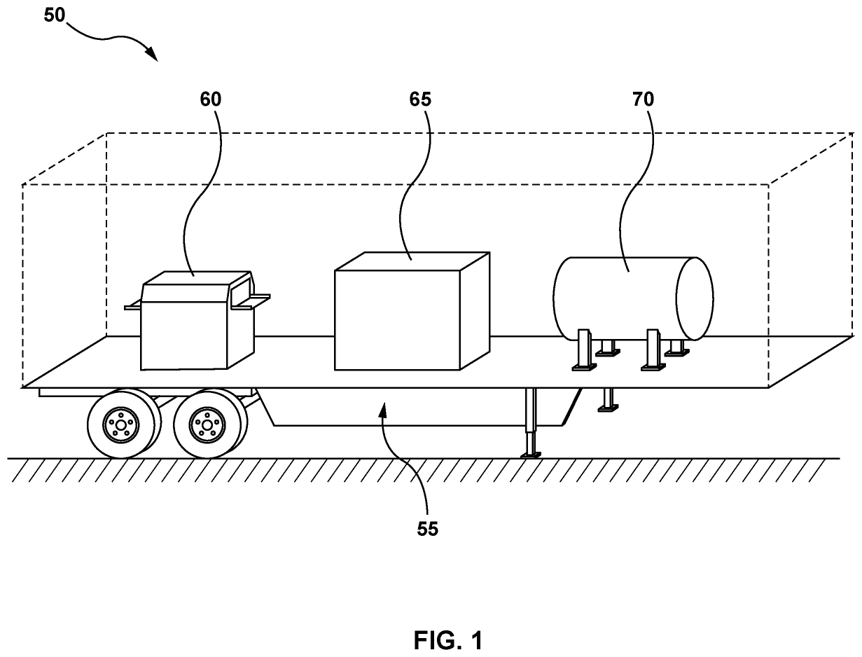

Referring to FIG. 1, a schematic representation of an apparatus to process food material, such as food waste, into a dry food product is generally shown at 50. The apparatus 50 may be part of a larger system to generate and process food waste. For example, the apparatus 50 may be part of a network of food processing facilities that generate compatible food waste to be processed into dry food product. The apparatus 50 includes a transportation platform 55, a sanitization unit 60, a food processor 65, and a freeze drying system 70.

The transportation platform 55 is to support the components of the apparatus 50. In particular, the transportation platform 55 is to be able to mechanically support the weight of the components and provide a stable structure onto which it can be mounted during transportation. The materials from which the transportation platform 55 is constructed is not particularly limited. In the present example, the transportation platform 55 is constructed from a plurality of steel beams to form a trailer, such as a standard transport trailer used to move goods on a highway. Accordingly, the transportation platform 55 may include wheels on an axle to form a trailer. In this example, the transportation platform 55 may be towed by a tractor from one location to another location in a ready to use state. It is to be appreciated by a person of skill with the benefit of this description that the transportation platform 55 may include additional components typically found on trailers. For example, the transportation platform 55 may include an air-ride suspension system to dampen seismic activity cause by an uneven road surface to protect the components when being moved between different locations.

In other examples, the transportation platform 55 may be configured for different modes of transportation. For example, the transportation platform 55 may be a rail car to be transported by train. Other examples may include a flotation device for the transportation platform 55 to be transported over water, such as a barge.

In the present example, the sanitization unit 60 is mounted at one end of the transportation platform 55 to receive food material for processing. The food material received by the sanitization unit 60 is not particularly limited. For example, the food material may be food waste received from a nearby food processing facility or other source of food material, such as a restaurant or event space. In particular, the food waste may be waste plant material from fruits and vegetables, such as watermelon, tomatoes, apples, strawberries, cucumbers, cabbage, kale, lettuce, onions, celery, etc. It is to be appreciated by a person of skill with the benefit of this description that the food waste received by the apparatus 50 may be of one type so that the dry food product that is produced may have a uniform flavor. In other examples, the apparatus 50 may receive food waste from a plurality of different sources and plant materials to produce a dry food product with a mixture of flavors.

The sanitization unit 60 is to remove contaminants from the food material received. Accordingly, the sanitization unit 60 provides sanitized food material for subsequent processing. The manner by which the sanitization unit 60 sanitizes the food material is not particularly limited. For example, the sanitization unit 60 may provide mechanism to wash the food material to remove dirt and other contaminants. In the present example, the sanitization unit 60 includes a mechanism to move the food material through a sanitization process automatically. As a specific example, the sanitization unit 60 may include a conveyor system to move food material received at one end and output sanitized food at another end of the conveyor system. In other examples, the sanitization unit 60 may be a station that provides a space and equipment for a separate sanitization machine or human work to sanitize the food material. The sanitized food is then passed to the food processor 65.

In the present example, the food processor 65 is to process the sanitized food. The manner by which food processor 65 processes the sanitized food is not particularly limited. For example, the food processor 65 may trim, mulch, chop, slice, dice, or puree the sanitized food for subsequent processing. The sanitized food from the sanitization unit 60 may be received in substantially same form factor as the food material received prior to sanitization. The food processor 65 is to reduce the size of the sanitized food to reduce subsequent processing by the freeze drying system 70. For example, if it is to be assumed that the food material received by the sanitization unit 60 are watermelon rinds, the rinds may be received in large pieces of non-uniform sizes of about 6 inches in length and width and of about 1 inch thick. The sanitized watermelon rinds may be similar in size after contaminants are removed. In this example, the food processor 65 may be a food processor with blades capable of cutting the watermelon rinds until it becomes a pulp. It is to be understood that depending on the starting food material or the target size for the starting material for the freeze drying system 70.

The sanitized food may be received from the sanitization unit 60 via a manual process. For example, a human user may collect the sanitized food from the sanitization unit 60 in a container and physically load it into the food processor 65. In other examples, the process may be automated where the such that the sanitized food may be moved from the sanitization unit 60 to the food processor 65 without any human intervention. For example, the sanitized food may be disposed on a conveyor system by the sanitization unit 60 which moves the sanitized food to the food processor 65 for further processing.

The processed and sanitized food is then moved from the food processor 65 to the freeze drying system 70 where the sanitized food is dehydrated with a freeze drying process to provide a dry food product. The manner by which the freeze drying system 70 dehydrates the food is no particularly limited. For example, the sanitized food may be placed on trays and into a chamber of the freeze drying system 70 for about 15 hours. In other examples, the sanitized food may be placed in the chamber of the freeze drying system 70 for up to about 24 hours or longer. In the present example, the freeze drying system 70 may be configured to process about 80 kilograms of sanitized food. It is to be appreciated that the freeze drying system 70 may be smaller to be more portable to process smaller batches of sanitized food in other examples. In further examples, the freeze drying system 70 may be larger and able to process over about 1000 kilograms of sanitized food in a single batch.

The dry food product provided by the freeze drying system 70 is not particularly limited and may be dependent on the food waste originally received by the apparatus 80. In the present examples, the dry food product is nutrient and flavor dense and can be used as a condiment to be added to a variety of recipes to enhance flavor. The dry food product may retain up to about 97 percent of the nutrients of the original food waste be shelf stable after processing. It is to be appreciated by a person of skill with the benefit of this description that the dry food product may be varied and that other examples may have less nutrients than the original food waste and in other examples, additional nutrients may be added to supplement the existing nutrients. Specific examples of use of the dry food product may include combining or adding the dry food product to sauces, water, marinades, soups, ice cream, dough, smoothies, juices, batters etc. Further examples may include using the dry food product to enhance the flavor, color or nutrient levels, of popcorn, protein, baked, grilled, BBQ, etc. The dry food product may also be directly consumed as a snack or meal in some examples.

In other examples, the dry food product may also have other uses beyond human consumption. For example, it may be used in for animal feed such as for pets or farm animals. The dry food product may also be used in the cosmetic and nutraceutical industries. By comparison with the original food waste, it is to be appreciated by a person of skill that the dry food product provided by the apparatus 50 may have several advantages. For example, the dry food product is shelf stable and may be stored without refrigeration for a long period of time, such as up to about 30 years while retaining substantially all the nutrients of the original food waste. The dry food product is also substantially lighter and occupies a smaller volume once the water is removed to reduce shipping and storage costs per unit of nutrition.

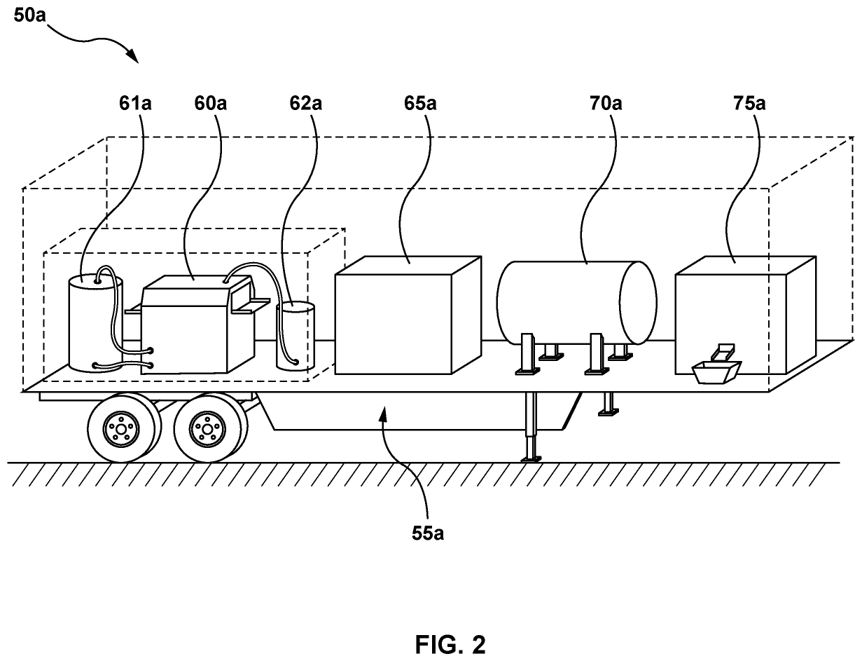

Referring to FIG. 2, a schematic representation of another apparatus 50a to process food waste into a dry food product is generally shown. Like components of the apparatus 50a bear like reference to their counterparts in the apparatus 50, except followed by the suffix “a”. In the present example, the apparatus 50a includes a transportation platform 55a, a sanitization unit 60a, a food processor 65a, a freeze drying system 70a, and a milling system 75a.

In the present example, the sanitization unit 60a includes systems to remove contaminants from the receive food material. It is to be appreciated that the sanitization unit 60a may be modified to include additional components or to omit some of the components described herein. In addition, the sanitization unit 60a may be substantially automated and include various control systems to operate its various components. In the present example, the sanitization unit 60a includes a water system 61a that may be used to wash the food material for processing from the source. In addition, the sanitization unit 60a may also include a tank 62a to store a sanitization solution for dispensing on the food material as it is being processed.

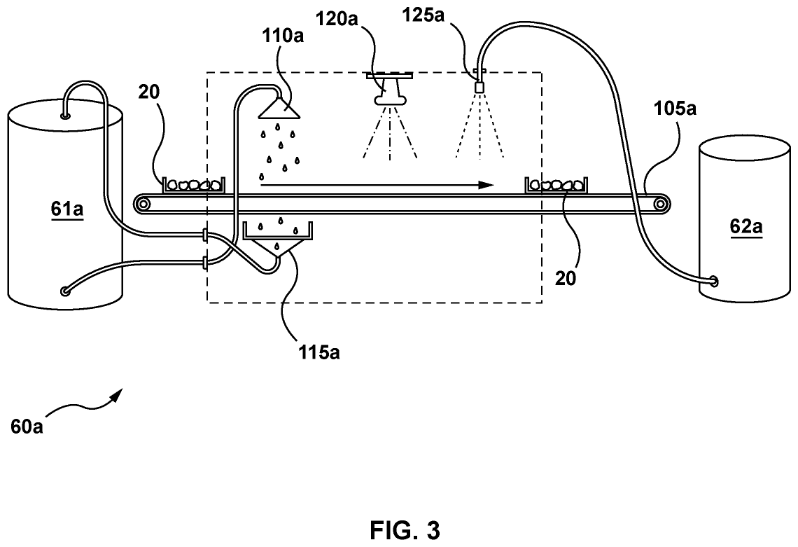

Referring to FIG. 3, the sanitization unit 60a is shown in greater detail. The sanitization unit 60a is the initial component of the apparatus 50a to receive food material, such as food waste, for processing. The manner by which the sanitization unit 60a receives the food material is not particularly limited and may involve the manual feeding of the food material or may involve an automated process. In the present example, the sanitization unit 60a receives a tray 20 of food material. The tray 20 may be automatically loaded from a hopper or may be loaded by a user. The tray 20 may be placed on a conveyor system 105a to automatically move the food material through one or more cleaning systems.

The tray 20 is passed through a washing station where a faucet 110a dispenses water over the food material in the tray 20. The water is used to rinse the food material to remove direct and water soluble contaminants. It is to be appreciated by a person of skill with the benefit of this description that the water dispensed from the faucet 110a is to be removed along with the contaminants. In the present example, a water recycler 115a is used to collect the waste water from the washing process to be reused. Accordingly, the water recycler 115a directs the water back into the water system 61a where it can be cycled back to the faucet. The water in the water system 61a may be replaced when the water gets dirty from extended use. In other examples, the contaminants in the water collected by the water recycler 115a may be filtered, distilled, or otherwise purified before reintroducing into the water system 61a. Although the washing station uses water as a solvent to rinse the food material, other solutions may be used, such as a soap solution. However, other solutions or solvents may affect the taste or quality of the final food product.

After washing the contents of the tray 20, the tray is moved to an ultraviolet sanitizer 120a where the contents of the tray are exposed to high energy ultraviolet light to neutralize any potential bacterial or viral contaminants. The manner by which the contents of the tray 20 are exposed are not particular limited. For example, the tray 20 may be moved to a predetermined position where the tray is to be irradiated for a period of time. In other examples, the contents of the tray 20 may be agitated or moved to reduce the chance of shadowing that can reduce the efficiency of the ultraviolet sanitizer 120a.

The tray 20 is moved through a sanitization dispenser 125a that is to dispense a sanitization solution from the tank 62a. The sanitization solution is not particularly limited. In the present example, the sanitization solution is a combination of hydrogen peroxide in an ozone environment.

It is to be appreciated that the sanitization unit 60a may be modified from the example described herein. For example, additional cleaning systems may be added. As another modification, one or more of the cleaning stations may be substituted with a mechanical treatment, such as bubbling or vibrations. In further examples, a manual process by a user may also be used. In addition, it is to be appreciated by a person of skill with the benefit of this description that the order by which the cleaning takes place may also be modified. In summary, the sanitization unit 60a is to clean the food material received for processing such that the food material which may include food waste can be fit for human consumption.

The milling system 75a is to receive the dry food product from the freeze drying system 70a for subsequent processing. In particular, the milling system 75a is to grind the dry food product into a powder. The powder may then be subsequently packaged for transportation and consumption.

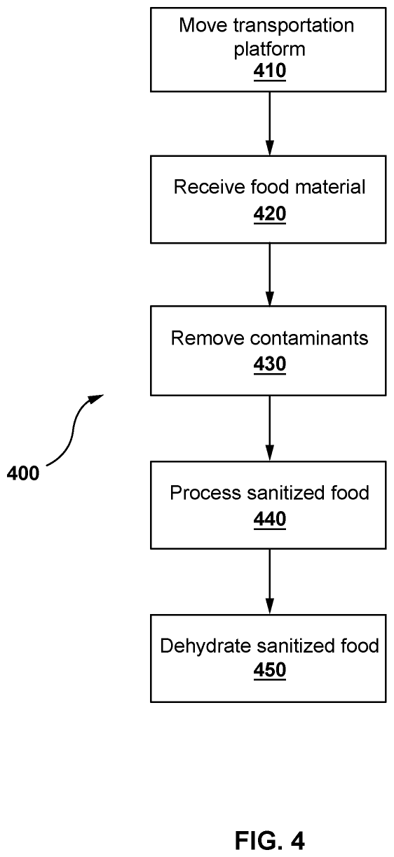

Referring to FIG. 4, a flowchart of a method of processing food material to produce a dry food product is generally shown at 400. In order to assist in the explanation of method 400, it will be assumed that method 400 may be performed with the apparatus 50 or 50a. Indeed, the method 400 may be one way in which the apparatus 50 may be used. Furthermore, the following discussion of method 400 may lead to a further understanding of the apparatus 50 and 50a as well as their components. In addition, it is to be emphasized, that method 400 may not be performed in the exact sequence as shown, and various blocks may be performed in parallel rather than in sequence, or in a different sequence altogether. Furthermore, it is to be appreciated that this is just an example method of a use of the apparatus 50 and 50a and that other uses are contemplated.

Beginning at block 410, the transportation platform 55 is move to a location near a source of food material from another location. The manner by which the transportation platform 55 is move is not particularly limited. For example, the transportation platform 55 wheels on an axle to form a trailer. In this example, the transportation platform 55 may then be towed by a tractor from one location to another location. In other examples, the apparatus 50 may be a large vehicle, such as a truck and the transportation platform 55 may be a part of the truck to be driven from one location to another.

Once the transportation platform 55 is positioned at a location, the apparatus 50 may receive food material from a source at block 420. In the present example, the food material is to be received at the sanitization unit 60 located at the end of the transportation platform 55. The manner by which food material as well as the form of the food material received at the sanitization unit 60 is not particularly limited. For example, the food material may be food waste collected from a nearby food processing facility. The food material may be preprocessed by the food processing facility or at an additional station prior to being received at the sanitization unit 60. The preprocessing is not particularly limited and may include sorting the food material into different types. For example, food waste from different plants may be sorted into different batches. Other examples of preprocessing may involve pealing or pitting some food waste if those portions of the food waste are not desired in the dry food product. Further examples, of preprocessing may include examining and discarding unacceptable food material which may not have a target nutrient value.

Block 430 comprises removing contaminants from the food material received at the sanitization unit 60 to provide sanitized food. In the present example, water may be used to wash the food material to remove dirt and other contaminants on the surface. This may involve rinsing water or a washing solution to remove contaminants on the surface. The process may involve using high pressured water and/or manual agitation in combination with the water. In some examples, the food material may also be sanitized with high energy ultraviolet light to neutralize any potential bacterial or viral contaminants of the surface. The ultraviolet light may be used in combination with the washing process, before the washing process, or after the washing process. In addition, a sanitization solution may also be used to remove or neutralize contaminants on the food material.

In the present example, the sanitization process operates autonomously once the food material is received at the sanitization unit 60. For example, the sanitization unit 60 may include a conveyor system to move the food material from one end to output sanitized food at another end of the conveyor system. In other examples, the sanitization unit 60 may use robotic arms to move trays of food material through the sanitization unit 60. In some examples, the sanitization unit 60 may involve a room with stations that provides a space and equipment for a human user to sanitize the food material with various equipment, such as those described above.

The sanitized food from block 430 is then processed at block 440. In the present example, the sanitized food may be trimmed, chopped, or pureed into a finer product for subsequent processing with a food processor. The processed food material is then dehydrated with a freeze drying system to provide the dry food product at block 450.

It is to be appreciated by a person of skill with the benefit of this description that the method 400 provides a process that can be carried out near a food processing facility to recover waste food material to be processed into a dry food product for subsequent use. Various advantages would be apparent to a person of skill with the benefit of this description as the method 400 can be used to reduce food waste. Since the apparatus 50 or 50a used to carry out the process is mobile, the process may be carried out conveniently at any location and the apparatus 50 or 50a may be moved around to collect waste food material.

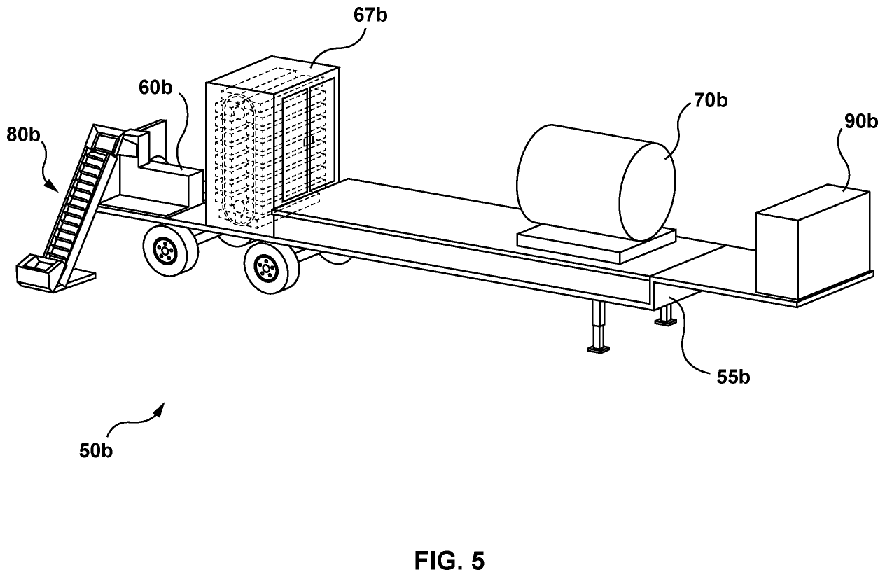

Referring to FIG. 5, a schematic representation of another apparatus 50b to process food waste into a dry food product is generally shown. Like components of the apparatus 50b bear like reference to their counterparts in the apparatus 50a, except followed by the suffix “b”. In the present example, the apparatus 50b includes a transportation platform 55b, a sanitization unit 60b, a freezer 67b, a freeze drying system 70b, a loading system 80b, and a mechanical components 90b.

It is to be noted that in the present example, the apparatus 50b does not include a food processor to process the sanitized food from the sanitization unit 60b. In this example, it is to be understood that the food material received at the sanitization unit 60b may be substantially small such that the processing step may be omitted. Accordingly, the sanitized food may be placed into the freezer 67b to reduce the overall processing time. In particular, the freezer 67b may pre-freeze the sanitized food for a period of time, such as about 24 hours which another batch dries in the freeze drying system 70b. In the present example, the overall processing time of the sanitized food mat be reduced by about 3 hours.

A loading system 80b is used to move food material to the sanitization unit 60b. The loading system 80b is not particularly limited and may be varied. In the present example, the loading system includes a container or hopper close to the ground. Food material to be processed may be carried to the loading system 80b and placed in the hopper. By disposing the hopper close to the ground, it is to be appreciated by a person of skill with the benefit of this description that food material may be easily fed into the apparatus. For example, the food material may be placed in a wheelbarrow or other transportation container to move from a source. In other examples, the food material may be automatically brought to the loading system 80b, such as via a conveyor belt or automated robot. The food material in the hopper of the loading system 80b may then be carried to the sanitization unit 60b with a conveyor to feed the food material into the sanitization unit 60b.

The mechanical components 90b are not particularly limited and may include machinery to support the apparatus 50b such that the apparatus 50b may operate independently at any location. For example, the mechanical components 90b may include a generator to power other components, computer controller systems, water tanks, heaters, climate control systems, etc.

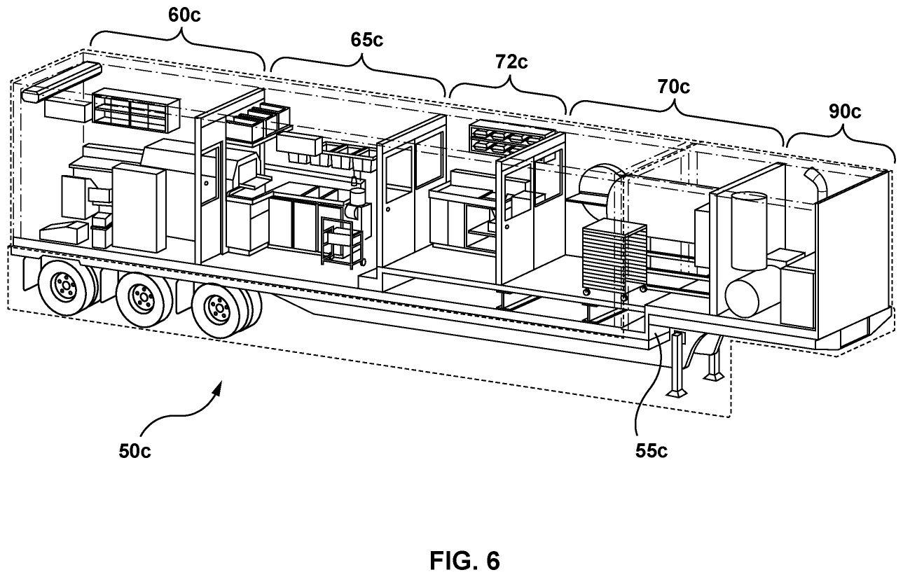

Referring to FIG. 6, a schematic representation of another apparatus 50c to process food waste into a dry food product is generally shown. Like components of the apparatus 50c bear like reference to their counterparts in the apparatus 50b, except followed by the suffix “c”. In the present example, the apparatus 50c includes a transportation platform 55c, a sanitization area 60c, a processing area 65c, a freeze drying area 70c, a post processing area 72c, and a mechanical room 90c.

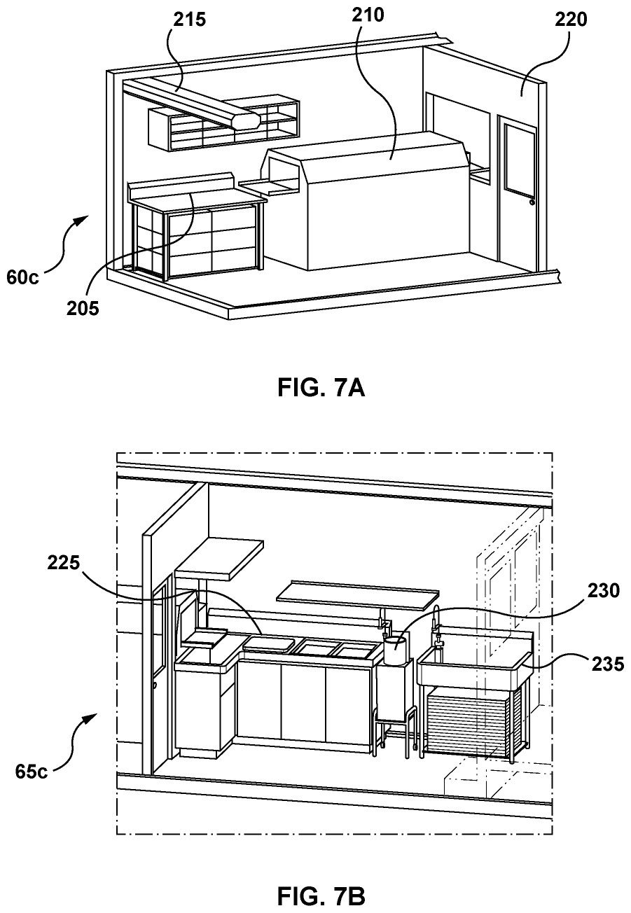

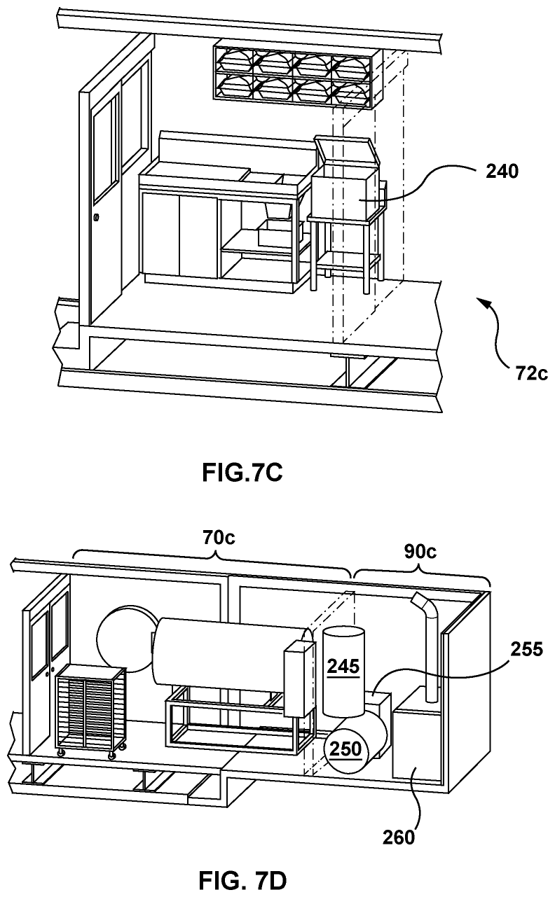

In the present example, the sanitization area 60c is a room where food material is received for processing. In particular, the sanitization area 60c provides space for a human user to carry out some sanitization steps alongside a more automated process. Referring to FIG. 7A, a more detailed view of the sanitization area 60c is shown. In the present example, the sanitization area 60c includes workspace 205 where a user may preprocess the food material as part of the sanitization process. The sanitization area 60c further includes an automated sanitizer 210 as well as an air curtain 215 to provide a barrier to the sanitization room to reduce contaminants from entering therein. At the other end of the sanitization area 60c, a wall is placed to also reduce contaminants from entering.

The processing area 65c may be another room in the apparatus 50c used to primarily break down sanitized food from the sanitization area 60c. In the present example, the processing area 65c also allows for a user to work inside with a workspace 225 to handle sanitized food from the sanitization area 60c. A food processor 230 may be use to puree the sanitized food and another workspace 235 may be provided to place the pureed food onto trays.

The freeze drying area 70c shown in FIG. 7D in the present example is a room with a freeze dryer to into which the trays from the processing area 65c are placed to dehydrate the sanitized food to provide the dry food product. Once the freeze drying cycle is completed, the trays may be moved to the post processing area 72c (FIG. 7C) where the dry food product is packaged using the vacuum sealer 240 for transportation or subsequent sale. In the present example, the mechanical room 90c include a hot water tank 245, a water storage tank 250, an air compressor 255, and a generator 260.

It is to be understood that variations are contemplated. For example, the transportation platform 55c of the apparatus 50c may be substituted with a stationary structure, such as a foundation. It is to be appreciated by a person of skill with the benefit of this description that in this variation, the apparatus 50c is to be installed at a permanent or semi-permanent location, which may be suitable for applications where there is a constant source of food material, such as on or near a farm or large food processing facility.

It is to be recognized that features and aspects of the various examples provided above may be combined into further examples that also fall within the scope of the present disclosure.

1. An apparatus comprising:
a transportation platform to be moved from a first location to a second location;
a sanitization unit mounted at an end of the transportation platform, wherein the sanitization unit is to receive food material, wherein the sanitization unit is to remove contaminants from the food material to provide sanitized food;
a food processor to process the sanitized food; and
a freeze drying system to dehydrate the sanitized food to provide a dry food product.

2. The apparatus of claim 1, wherein the sanitization unit includes a water system to wash the food material.

3. The apparatus of claim 2, wherein the water system includes a water recycler to recycle used water.

4. The apparatus of claim 1, wherein the sanitization unit includes an ultraviolet sanitizer.

5. The apparatus of claim 1, wherein the sanitization unit is to dispense a sanitization solution to wash the food material.

6. The apparatus of claim 1, wherein the freeze drying system is to receive a tray, wherein the tray is to hold the sanitized food.

7. The apparatus of claim 1, further comprising a milling system to grind the dry food product into a powder.

8. The apparatus of claim 1, wherein the transportation platform is a trailer, and wherein the trailer is to be towed.

9. A method comprising:
moving a transportation platform from a first location to a second location;
receive food material at a sanitization unit mounted at an end of the transportation platform;
removing contaminants from the food material to provide sanitized food at the sanitization unit;
processing the sanitized food; and
dehydrate the sanitized food with a freeze drying system to provide a dry food product.

10. The method of claim 9, wherein removing the contaminants comprises washing the food material with a water system.

11. The method of claim 10, wherein further comprising recycling used water for subsequent use.

12. The method of claim 9, wherein removing the contaminants comprises using an ultraviolet sanitizer to kill bacteria.

13. The method of claim 9, wherein removing the contaminants comprises dispensing a sanitization solution to wash the food material.

14. The method of claim 9, further comprising placing the sanitized food on a tray, and placing the tray in the freeze drying system.

15. The method of claim 9, further comprising grinding the dry food product into a powder after drying.

16. The method of claim 9, wherein moving the transportation platform comprises towing the transportation platform.
